(19) United States
(12) Patent Application Publication
(10) Pub. No.: US 2008/0196411 A1
(43) Pub. Date: Aug. 21, 2008

(54) Nuclear Power Plant and a Steam Turbine

(76) Inventor: Mikhail Yurievich Kudryavtsev, ul. Lyublinskaya (RU)

Correspondence Address: PATENTTM.US, P. O. BOX 82788, PORTLAND, OR, 97282-0788, US

(21) Appl. No.: 11/915,370

(22) PCT Filed: May 18, 2006
(86) PCT No.: PCT/RU2006/000248

§ 371 Date: Nov. 23, 2007

(30) Foreign Application Priority Data
May 25, 2005 (RU) 2005115761

(51) Int. Cl. G21D 5/08; G21C 15/00

(52) U.S. Cl. 60/644.1; 376/402

(57) ABSTRACT

The group of inventions relates to nuclear techniques and to power industry.

The nuclear power plant contains a nuclear reactor (1) cooled by liquid metal, for example lead. Heated-up liquid metal is cooling in heat exchanger <<liquid metal-gas>> (3). This heat exchanger is embodied as not-mixing heat exchanger. The pump (2) moves cooled liquid metal through the filters into the reactor (1). The compressor (4) moves gas through heat exchanger <<liquid metal-gas>> (3) into gas turbines (8, 9, 10, 22, 23, 24). After gas turbines this gas vaporizes and overheats the water in heat exchangers <<gas-water>> (5, 6, 7) and moves back to compressor (3). Produced steam moves the steam turbines (12, 13), condenses into the water by means of condenser (15) and circulation pump (16) and then is moved by the pumps (17, 20) back to heat exchangers <<gas-water>> (5, 6, 7). At least one of gas turbines (22, 23, 24) is coupled by shaft with at least one of said pumps (16, 17, 20), and in steam turbines (12, 13) the channels are embodied for the heating medium. Said channels are embodied in the directing device of the steam turbine (12, 13) and/or in driving wheels of the steam turbine (12, 13). Said channels are series connected among them in a direction of a steam course in the turbine (12, 13). The gas after gas turbines (8, 9, 10, 22, 23, 24) is used besides heat exchangers (5, 6, 7) as said heating medium and after that moves into compressor (3). The nitrogen, air, helium, carbon dioxide or their mix are used as said gas.

Said group of inventions makes it possible to increase the heat efficiency of nuclear power plant with a reactor cooled by liquid metal at least up to 50% and to preserve high heat efficiency of this plant at frequent multiple reduction of used capacity of this plant, for example at nights.

### FIELD OF THE INVENTION

The group of inventions relates to nuclear techniques and to power industry.

### PRIOR ART

The nuclear power plant is known that includes a nuclear reactor cooled by the liquid metal, not-mixing heat exchangers for evaporation of water by means of this metal and the steam turbines moved by received steam. At that sodium is used as liquid metal (see patent SU 319142, F 01 K 27/00, 28.10.1971).

Lack of this plant at use of sodium as liquid metal is high chemical activity of sodium to the water. Such activity demands expensive technical measures to prevent the emergency contact of sodium with water at loss of tightness of heat exchangers and to reduce the consequences of formation of gaseous hydrogen in explosive concentration. Heat efficiency of this plant (the factor of transformation of a nuclear reactor heat into energy of rotation of turbines) does not exceed 44% and depends on capacity at which plant is used. For preservation the heat efficiency at a high level when plant with steam turbines is used at multiple reduced capacity (for example, at a night minimum of power consumption) it is expedient to stop a part of steam turbines of plant, including the auxiliary steam turbines actuating pumps (for example, supplying pumps) that steam turbines are provided with. However in the plant described above the admissible duration of frequent start-up of steam turbines from the stopped condition does not allow the restoring of full capacity of plant for short time, for example, at transition from a night minimum to a morning maximum of power consumption. Therefore multiple reduction of capacity at a night minimum of power consumption can be carried out in this plant only without stopping of steam turbines. That considerably reduces heat efficiency at the minimal used capacity.

The steam turbine is known that contains system of heating of the steam valve for prevention of hit the drops of water into the turbine (see Inventor's Certificate SU 1815330, F 01 D 1/02, 15.05.1993). However in this turbine, as well as in other known steam turbines, the starting warming up of the turbine is carried out by supplying steam into the turbine. Thus because of high heat transferring from the steam to various turbine elements there arises an unequal degree of warming up, defined by elements' weight and geometrical form. Also condensation of steam is possible on enough cold elements of the turbine. The unequal degree of warming up of turbine elements and necessity of removal of a condensate increases the admissible duration of start-up of the turbine.

The closest to the invention on technical essence the nuclear power plant is that contains a nuclear reactor, cooled by liquid metal, for example lead, heat exchangers <<liquid metal-gas>> for heating the intermediate gaseous heat-carrier by heat of the liquid metal, connected with them by gas pipes not-mixing heat exchangers <<gas-water>> for heating and evaporation the water by heat of heated-up gas, compressors for moving cooled gas from an output of heat exchangers <<gas-water>> to an input of heat exchangers <<liquid metal-gas>> and steam pipes for supplying produced steam to a user. At that the mixing heat exchangers <<liquid metal-gas>> are used (see patent RU 2212066, G21 D 1/00, F 22 B 1/06, 9/10/2003). In this plant the use of lead as liquid metal excludes formation of gaseous hydrogen at emergency contact of liquid metal to water. Also the use of the intermediate gaseous heat-carrier prevents the freezing of lead at emergency decrease in temperature or pressure of evaporated water. However the use in this plant mixing heat exchangers <<liquid metal-gas>>, polluting the gas by vapor of metal, does not allow to use heat energy of gas in power plants to increase the heat efficiency of plant.

Regarding the steam turbine as object of the invention, the closest is the steam turbine containing the device for intermediate steam heating by heat of the heating medium during steam expansion in the turbine. At that intermediate steam heaters are located separately from the turbine and connected with it by steam pipes (see a book by B. G. Ganchev, L. L. Kalishevsky, R. S. Demeshev, etc., under N. A. Dollezhal's general edition, “Nuclear Power Plants”, the Manual for High Schools, Moscow, Nuclear Power Publishing House, 1990, p. 36-37). Intermediate heating of steam by heat of the heating medium during steam expansion in the turbine increases heat efficiency of the steam turbine. This heat efficiency rising is so higher as more times during steam expansion in the turbine the intermediate steam heating is carried out.

Losses on steam friction at its moving from the turbine up to an intermediate heater and back so as capital expenses for intermediate heaters and pipelines to them compel to apply intermediate steam heating, as a rule, only once during expansion in the turbine. More frequent intermediate steam heating during steam expansion in the turbine is desirable for increasing of heat efficiency of plants with steam turbines.

### SUMMARY OF THE INVENTION

Problem on which decision the present invention is directed is to increase heat efficiency of nuclear power plant with a reactor cooled by liquid metal and to preserve high heat efficiency of this plant at frequent multiple reduction of used capacity of this plant, for example at nights.

The said problem is solved because the nuclear power plant contains a nuclear reactor cooled by liquid metal, for example lead, heat exchangers <<liquid metal-gas>> for heating gas by heat of the liquid metal, connected with them by gas pipes the not-mixing heat exchangers <<gas-water>> for heating and evaporation the water by heat of heated-up gas, compressors for moving cooled gas from an output of heat exchangers <<gas-water>> to an input of heat exchangers <<liquid metal-gas>> and steam pipes for supplying the produced steam to a user, at that heat exchangers <<liquid metal-gas>> are embodied as not-mixing heat exchangers, gas outputs of these heat exchangers are connected to inputs of gas turbines, outputs of gas turbines are connected to gas inputs of heat exchangers <<gas-water>>, steam pipes for supplying the produced steam to a user are connected to the steam turbines provided with pumps, for example supplying pumps, withal at least one gas turbine is coupled by shaft with at least one of these pumps, and in steam turbines the channels are embodied for the heating medium, said channels are connected by their input with the gas output of at least one gas turbine, and by their output with an input of at least one compressor.

The nitrogen, air, helium, carbon dioxide or their mix can be used as said gas.

The nuclear reactor can be provided with filters for cleaning the liquid metal cooled in heat exchangers.

Regarding the steam turbine as object of the invention, the task in view is solved because the steam turbine is provided with a device for intermediate steam heating by heat of the heating medium during steam expansion in the turbine, said device being located separately from the case of the turbine and connected with it by steam pipes, at that the channels for heating medium are embodied in the directing device of the turbine and/or in driving wheels of the turbine, the heated-up gas for intermediate steam heating is used as said heating medium, withal at least one of channels is connected by its input with an output of gas from at least one of gas turbines, and at least one of channels is connected by its output with an input of compressor.

The channels for the heating medium can be series connected among them in a direction of a steam course in the turbine.

During the analysis of heat efficiency of nuclear power plants it has been established, that if the described nuclear power plant use the gas-turbine closed cycle without heat recovery and use the usual steam cycle, the heat efficiency of said plant can reach 50% at heating the gas in heat exchangers <<liquid metal-gas>> up to temperature 790 K.

Gas turbines are easier started at any temperature and more quickly accept loading, than steam turbines. Besides unlike steam turbines at gas ones it is easier to adjust capacity by change of pressure of a working medium with preservation of high heat efficiency in a wide interval of loadings. Therefore in described nuclear power plant the use of the gas turbines for a drive of pumps, for example supplying pumps of steam turbines, increases heat efficiency of plant at frequent reduction of used capacity, for example at nights. This heat efficiency increases as due to higher heat efficiency at low power of gas turbines on comparison with steam ones, and due to faster acceptance of loading by the pumps, reducing duration of the start-up of steam turbines up to the size, allowing to stop for the night a part of steam turbines and to use the remained part on higher capacity corresponding higher heat efficiency.

Additional intermediate steam heating during steam expansion in the turbine by supplying the gas after gas turbines into the channels embodied in the directing device of the steam turbine and/or in driving wheels of the steam turbine also increases heat efficiency of described nuclear power plant. The additional intermediate steam heating is the most effective at pass of the heating medium through channels in a direction of a steam course.

The warming up of steam turbines by means of the gaseous heat-carrier, which is passing through channels for the heating medium, with the minimal expenses supports the stopped steam turbines in a hot condition. The hot condition reduces duration of start-up of steam turbines up to the size, allowing to stop for the night a part of steam turbines and to use the remained part on higher capacity that corresponding higher heat efficiency.

In the nearest analogue of nuclear power plant the use of the intermediate gaseous heat-carrier, polluted by vapor of radioactive metal, as a working medium in gas turbines and as the heating medium in steam turbines is complicated because of sedimentation of metal's vapor on a surface of turbines.

Air is most accessible to use as the gaseous heat-carrier of described nuclear power plant. However in air under action of an ionizing radiation the oxides of nitrogen are formed. The oxides of nitrogen make active corrosion on gas contour's surfaces. Carbon dioxide costs more than air, but shows smaller corrosion activity, than oxides of nitrogen. Nitrogen costs more than carbon dioxide, but shows smaller corrosion activity, than carbon dioxide. Helium costs more than nitrogen, but at first is chemically inert, and secondly is not activated in heat exchangers <<liquid metal-gas>>. Last circumstance makes easier the radiating protection of these heat exchangers against radiation from a reactor.

For freeing liquid metal from dross that is product of corrosive-erosive destruction of heat exchangers <<liquid metal-gas>> it is expedient to establish filters of liquid metal before the liquid metal input of a nuclear reactor's active zone.

### BRIEF DESCRIPTION OF THE DRAWINGS

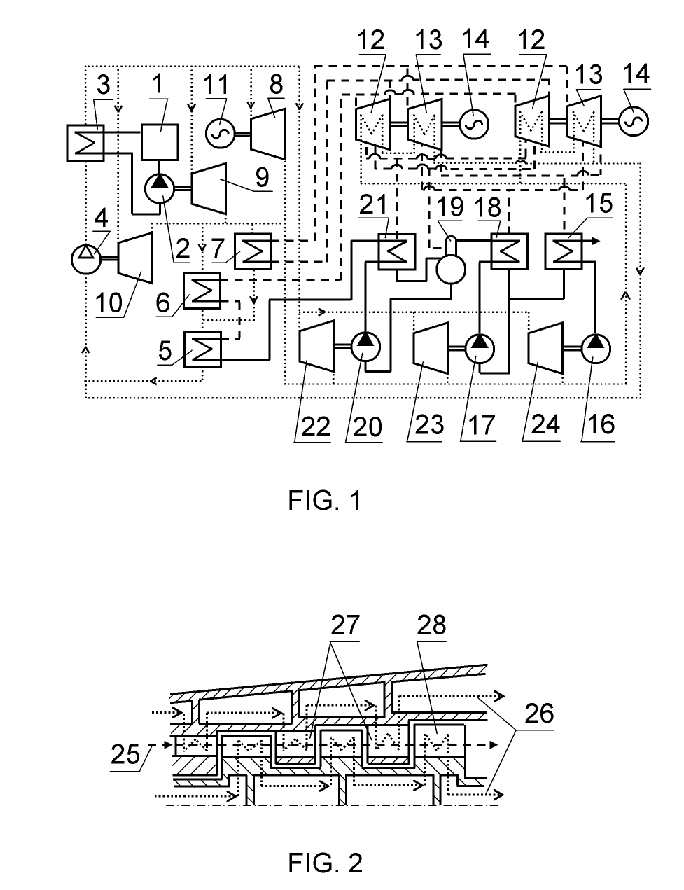

On FIG. 1 the basic scheme of nuclear power plant is presented. FIG. 2 schematically shows the longitudinal section of a flowing part of the steam turbine. There channels for the heating medium shown conditionally in the directing device and in driving wheels of the turbine. The chain of points designates way of gas pass. The dotted line designates way of steam pass.

The nuclear power plant (see FIG. 1) contains a nuclear reactor (1) cooled by liquid metal. The pump (2) moves the liquid metal through a circulation contour. The not-mixing heat exchanger (3) <<liquid metal-gas>> heats up the gas by cooling of liquid metal. The compressor (4) supply the cooled gas from gas output of not-mixing heat exchanger (5) <<gas-water>> to gas input of heat exchanger (3). The gas output of heat exchanger (3) is connected to an input of gas turbines (8, 9, 10). The gas turbine (8) is coupled by shaft to the electric generator (11). The gas turbine (9) is coupled by shaft to the pump (2). The gas turbine (10) is coupled by shaft with compressor (4). Outputs of gas turbines are connected to the gas inputs of not-mixing heat exchangers (6, 7) <<gas-water>>. The gas output of heat exchangers (6, 7) is connected to the gas input of heat exchanger (5).

The heat exchanger (5) for water evaporating is connected by a steam pipe to heat exchanger (6) for steam overheating. The steam output from heat exchanger (6) is connected to an input of the high pressure steps (12) of steam turbines. The steam output from the high pressure steps (12) is connected to an input of heat exchanger (7) for intermediate steam heating. The steam output from heat exchanger (7) is connected to an input of the low pressure steps (13) of steam turbines. Steps (12) and (13) of each steam turbine are coupled by the general shaft to theirs electric generator (14). The steam output from the low pressure steps (13) is connected to the condenser (15). The circulating water input of condenser (15) is connected to the circulating pump (16). The condensate output of the condenser (15) is connected to an input of condensate pump (17). The output of condensate pump (17) is connected to the condensate input of the low pressure heater (18). The output of heated condensate from the low pressure heater (18) is connected to the top part of deaerator (19). The deaerated water output of deaerator (19) is connected to an input of the supplying pump (20). The output of the supplying pump (20) is connected to the condensate input of the high pressure heater (21). The output of heated condensate from the high pressure heater (21) is connected to the water input of vaporizer (5).

The output of gas from heat exchanger (3) is connected in addition to an input of gas turbines (22, 23, 24). At that the gas turbine (22) is coupled by shaft with supplying pump (20), the gas turbine (23) is coupled by shaft with condensate pump (17), the gas turbine (24) is coupled by shaft with circulating pump (16). Outputs of gas turbines (22, 23, 24) is connected to the gas input of heat exchangers (6, 7).

In steps (12, 13) of steam turbines the channels are embodied for the heating medium. At that inputs of these channels can be connected to outputs of gas turbines (8, 9, 10, 22, 23, 24) and outputs of these channels are connected to an input of compressor (4).

In the steam turbine (see FIG. 2), containing the device for intermediate steam heating by the heating medium during expansion of steam (25) in the turbine, channels (26) for the heating medium are embodied in the directing device (27) of turbine and in driving wheels (28) of turbine.

Channels (26) for the heating medium are series connected among them in a direction of a steam course in the turbine.

### DESCRIPTION OF PREFERRED EMBODIMENTS

The described group of inventions can be carried out as follows.

In a nuclear reactor (1) liquid metal, for example lead, heats up to temperature 830 K. In not-mixing heat exchanger (3) <<liquid metal-gas>> this metal is cooled up to 670 K and again is moved into a reactor (1) by pump (2). Heat of this metal in heat exchanger (3) <<liquid metal-gas>> heats the gas, for example, nitrogen, from temperature 620 K up to 790 K. Heated nitrogen goes into gas turbine unit with the closed cycle without heat recovery, and after use in gas turbines (8, 9, 10, 22, 23, 24) nitrogen gets temperature 580 K. In not-mixing heat exchangers (5, 6, 7) <<gas-water>> nitrogen is cooled up to 460 K, giving heat to the water evaporated at pressure 5.5 MPa. The cooled nitrogen is compressed by compressor (4) up to a degree of compression p=3, corresponding to temperature 620 K, and moves into heat exchanger (3) <<liquid metal-gas>>.

Produced in heat exchangers (5, 6) “gas-water” steam with pressure 5.5 MPa and temperature 540 K moves into steam turbines (steps 12 and 13), provided with the devices for intermediate steam heating by heat of nitrogen during steam expansion in the turbine. In addition to the intermediate steam heater (7) located separately from turbines (12, 13) and connected with them by steam pipes, each steam turbine is provided with the intermediate steam heater executed in the form of channels (26) for nitrogen in the directing device (27) of turbines and/or in driving wheels (28) of turbines. The part of nitrogen besides heat exchangers (5, 6, 7) “gas-water” is brought to channels (26) for intermediate heating of steam (25) during expansion in the turbine. This part of nitrogen passes through the channels series to a direction of course of the steam (25) in the turbine. Thus the heat efficiency of steam turbines not less than 33% and the heat efficiency of nuclear power plant not less than 50% are reached.

At a stop of one of steam turbines at night it remains in a hot condition due to supplying the part of nitrogen besides heat exchangers (5, 6, 7) “gas-water” to channels (26) of this turbine.

### INDUSTRIAL APPLICABILITY

The present invention may be used in nuclear power engineering and in power industry for increasing the heat efficiency of power plants.

What is claimed is:

1. A nuclear power plant containing a nuclear reactor cooled by liquid metal, for example lead, heat exchangers <<liquid metal-gas>> for heating gas by heat of the liquid metal, connected with them by gas pipes the not-mixing heat exchangers <<gas-water>> for heating and evaporation the water by heat of heated-up gas, compressors for moving cooled gas from an output of heat exchangers <<gas-water>> to an input of heat exchangers <<liquid metal-gas>> and steam pipes for supplying the produced steam to a user, CHARACTERIZED IN THAT heat exchangers <<liquid metal-gas>> are embodied as not-mixing heat exchangers, gas outputs of these heat exchangers are connected to inputs of gas turbines, outputs of gas turbines are connected to gas inputs of heat exchangers <<gas-water>>, steam pipes for supplying the produced steam to a user are connected to the steam turbines provided with pumps, for example supplying pumps, withal at least one gas turbine is coupled by shaft with at least one of these pumps, and in steam turbines the channels are embodied for the heating medium, said channels are connected by their input with the gas output of at least one gas turbine, and by their output with an input of at least one compressor.

2. A plant according to claim 1, CHARACTERIZED IN THAT the nitrogen, air, helium, carbon dioxide or their mix are used as said gas.

3. A plant according to claim 1, CHARACTERIZED IN THAT the nuclear reactor is provided with filters for cleaning the liquid metal cooled in heat exchangers.

4. A steam turbine provided with a device for intermediate steam heating by heat of the heating medium during steam expansion in the turbine, said device being located separately from the case of the turbine and connected with it by steam pipes, CHARACTERIZED IN THAT the channels for heating medium are embodied in the directing device of the turbine and/or in driving wheels of the turbine, the heated-up gas for intermediate steam heating is used as said heating medium, withal at least one of channels is connected by its input with an output of gas from at least one of gas turbines, and at least one of channels is connected by its output with an input of compressor.

5. A turbine according to claim 4, CHARACTERIZED IN THAT the channels for the heating medium are series connected among them in a direction of a steam course in the turbine.
